(19) United States
(12) Patent Application Publication
(10) Pub. No.: US 2011/0214809 A1
(43) Pub. Date: Sep. 8, 2011

(54) BONDING APPARATUS AND BONDING METHOD

(75) Inventor: Masahiko Sugiyama, Nirasaki-shi (JP)

(73) Assignee: TOKYO ELECTRON LIMITED, Tokyo (JP)

(21) Appl. No.: 12/922,288

(22) PCT Filed: Sep. 11, 2009
(86) PCT No.: PCT/JP2009/065889

§ 371 Date: Sep. 13, 2010

(30) Foreign Application Priority Data
Nov. 14, 2008 (JP) 2008-292684
Nov. 14, 2008 (JP) 2008-292686

(51) Int. Cl. B32B 37/10; B32B 37/02; B32B 37/06; B32B 37/14; B32B 37/16

(52) U.S. Cl. 156/285; 156/538; 156/498

(57) ABSTRACT

A bonding apparatus includes a first holding section which places and holds a first member on an upper surface, and a second holding section which adsorbs and holds a second member on a lower surface. The second holding section is configured such that a center section bends due to a predetermined pressure. The second holding section includes an intake mechanism which sucks atmosphere of a bonding space between the first holding section and the second holding section. A protrusion which protrudes downward along an outer circumferential lower surface of the second holding section is formed on the outer circumferential lower surface. A sealing member which holds an air-tightness of the bonding space and has elasticity is formed in a lower surface of the protrusion. A height adjusting mechanism which abuts on the protrusion and can adjust the vertical distance between the first member and the second member is formed on a side surface of the first holding section.

### TECHNICAL FIELD

The present invention relates to a bonding apparatus for bonding two members formed as thin plates, and a bonding method using the bonding apparatus.

### BACKGROUND ART

Recently, in processes of manufacturing semiconductor devices or micro electro mechanical systems (MEMSs), semiconductor wafers (hereinafter, referred to as “wafers”) have been fabricated with large diameters. In addition, in a certain process such as a mounting process, a thin wafer is required. For example, when a thin wafer having a large diameter is conveyed or polished, the wafer may be warped or cracks may be generated in the wafer. Therefore, in order to reinforce the wafer, for example, the wafer may be adhered to another wafer or a glass substrate as a reinforcing substrate.

Bonding of the above-described wafers is performed by disposing an adhesive between the wafers. However, when the wafers are bonded to each other in a state where the adhesive is disposed between the wafers, voids may be generated between the wafers. When the voids are generated between the wafers, performances of a fabricated semiconductor device may be degraded, and thus, it is required to prevent the generation of voids.

Therefore, Patent Document 1 suggests a bonding apparatus including a chamber for receiving two wafers that are disposed on an upper and lower side (hereinafter, the wafer disposed on an upper side is referred to as an upper wafer, and the wafer disposed on a lower side is referred to as a lower wafer), a pressing pin formed in the chamber to press a center portion of the upper wafer, and a spacer for supporting an outer circumference of the upper wafer and capable of retracting from the outer circumference of the upper wafer. When the bonding apparatus disclosed in the patent document 1 is used, the wafer bonding operation is performed in the vacuum chamber in order to prevent voids from being generated between the wafers. In detail, in a state where the upper wafer is supported by the spacer, the pressing pin presses the center portion of the upper wafer so that the center portion of the upper wafer abuts on the lower wafer. After that, the spacer supporting the upper wafer is retracted, and then, an entire surface of the upper wafer abuts on an entire surface of the lower wafer so that the wafers are bonded to each other.

In addition, Patent Document 2 suggests a bonding apparatus including a holding plate for holding a first member that is disposed on an upper side, a table on which a second member that is disposed on a lower side is mounted, and a vacuum chamber ring formed on an outer circumference of the holding plate. In the bonding apparatus, the to holding plate and the vacuum chamber ring are descended toward the table, and thus, the vacuum chamber ring and the table contact each other via a seal ring. The holding plate, the vacuum chamber ring, and the table form a vacuum chamber. Next, atmosphere in the vacuum chamber is evacuated through an opening that is formed in a side surface of the vacuum chamber ring so that inside of the vacuum chamber becomes a vacuum atmosphere. After that, the holding plate is further descended toward the table so that the first and second members are bonded to each other.
(Patent Document 1) Japanese Laid-open Patent Publication No. 2004-207436
(Patent Document 2) International Patent Publication No. WO2004/026531

### DISCLOSURE OF THE INVENTION

### Technical Problem

However, when the bonding apparatus disclosed in Patent Document 1 is used, the entire inside of the chamber should be maintained in a vacuum condition, and it requires a lot of time to make a vacuum atmosphere in the chamber after the wafers are received in the chamber. Therefore, throughput of the total wafer processing is degraded.

In addition, according to the bonding apparatus disclosed in Patent Document 1, the upper wafer is supported only by the spacer when the pressing pin presses the center portion of the upper wafer. Accordingly, the location of the upper wafer may be misaligned with the lower wafer.

Also, according to the bonding apparatus disclosed in Patent Document 2, the two members are bonded under the vacuum atmosphere; however, it is substantially, difficult to make the inside of the vacuum chamber completely vacuum atmosphere. That is, air exists between the first member and the second member. Since, the entire surface of the first member and the entire surface of the second member are simultaneously bonded to each other under the above atmosphere, the air between the first member and the second member cannot be completely removed. Thus, voids may be generated between the members after bonding.

Considering the above matters, the present invention prevents voids from being generated between two members and performs the bonding of the members efficiently, when the two members are bonded.

### Technical Solution

In an embodiment, there is provided a bonding apparatus for bonding two members to each other, the bonding apparatus including: a first holding section that places and holds a first member on an upper surface thereof; a second holding section which is formed above and facing the first holding section and holds a second member on a lower surface thereof; and an intake mechanism which sucks atmosphere between the first holding section and the second holding section, wherein the second holding section may be an elastic body, a portion of which bends due to a predetermined pressure.

According to the present invention, an intake mechanism intakes atmosphere from a space between the first holding section and the second holding section (hereinafter, the space will be referred to as “bonding space”) to make a pressure difference between a pressure applied to an upper surface of the second holding section and a pressure in the bonding space, and by the pressure difference as predetermined pressure, a portion of the second holding section which holds the second member may be bent. Then, the bent portion of the second member abuts on the first member. After that, the intake mechanism further intakes the atmosphere of the bonding space so that the pressure in the bonding space is lower than a pressure between the second holding section and the second member, and thus, the second member falls down from the second holding section and an entire surface of the second member abuts on an entire surface of the first member. At this time, the second member sequentially abuts on the first member from the bent portion of the second member toward a radial direction outer side of the second member. That is, for example, even when air that may generate voids exists in the bonding space, the air always exists on an outer portion of the abutting region between the second member and the first member, and then, the air may be pushed out from the abutting portion between the members. Therefore, according to the present invention, the members may be bonded to each other while preventing voids from generating between the members. Moreover, according to the present invention, it is enough only to intake the atmosphere of the tiny bonding space as described above without the need to perform the bonding of the members in the vacuum atmosphere like the conventional art. Accordingly, the bonding of the members may be performed efficiently in a short time. Further according to the present invention, since the bent portion of the second member may abut on the first member in a state where the second member is held by the second holding section, the bonding of the members may be performed without misalignment of location of the second member with the first member.

The bonding apparatus may further include an air-tight holding mechanism which holds air-tightness of a space between the first holding section and the second holding section. The air-tight holding mechanism may include: a protrusion which is formed along an outer circumferential lower surface of the second member and protrudes downward from the outer circumferential lower surface of the second member; a sealing member which is formed in a closed circular shape on a lower surface of the protrusion and holds air-tightness of a space surrounded by the first holding section, the second holding section, and the protrusion; and a height adjusting mechanism which is formed on an outer side of the sealing member and abuts on the lower surface of the protrusion to adjust a vertical distance between the first member and the second member. The sealing member may have elasticity.

The bonding apparatus may further include a moving mechanism which moves the first holding section in the vertical direction and in a horizontal direction, and rotates the first holding section in the horizontal direction.

The moving mechanism may be provided on a lower side of the first holding section, and a predetermined vertical gap may be formed between the first holding section and the moving mechanism.

The bonding apparatus may further include: a pressing mechanism which is formed on an upper surface of the second holding section and presses the second holding section downward; and a fixing mechanism which holds the first holding section to fix a vertical location of the first holding section to a predetermined location.

The pressing mechanism and the fixing mechanism may be supported by a supporting plate which is provided on an upper side of the second holding section.

The pressing mechanism may include a container which is formed so as to freely expand and contract in the vertical direction and cover at least the second member, and may press the second holding section by introducing a fluid into the container.

The bonding apparatus may further include a position adjusting mechanism which controls the moving mechanism so that a horizontal location of the first member is aligned with the second member.

At least one of the first holding section and the second holding section may include a heating mechanism which heats at least one of the first member and the second member. At least one of the first holding section and the second holding section may include a cooling mechanism which cools down at least one of the first member and the second member.

The second holding section may adsorb and hold the second member by suction. According to the present invention, since the second member is adsorbed and held, a spacer for supporting an upper wafer in the conventional bonding apparatus may not be necessary, and thus, the bonding apparatus may be made smaller.

According to another aspect of the present invention, there is provided a bonding method of bonding two members to each other by using a bonding apparatus, the bonding apparatus including: a first holding section which places and holds a first member on an upper surface thereof; a second holding section which is formed above and facing the first holding section and holds a second member on a lower surface thereof; and an intake mechanism which sucks atmosphere between the first holding section and the second holding section, wherein the second holding section may be an elastic body, a portion of which bends due to a predetermined pressure, and the bonding method including: disposing the first holding section and the second holding section so that a vertical distance between the first holding section and the second holding section becomes a predetermined distance; intaking atmosphere between the first holding section and the second holding section so that a portion of the second holding section which holds the second member bends and the bent portion of the second member abuts on the first member; and further intaking the atmosphere between the first holding section and the second holding section so that an entire surface of the second member is bonded to an entire surface of the first member.

According to a reference example of another aspect, a bonding apparatus for bonding two members by pressing and contacting the two members by a predetermined pressure after aligning locations of the two members, the bonding apparatus includes: a first holding section for holding a first member, a second holding section formed so as to face the first holding section and holding a second member, a moving mechanism for moving the first holding section in a vertical and a horizontal direction and rotating the first holding section in the horizontal direction, a pressing mechanism formed so as to contact the second holding section and pressing the second holding section toward the first holding section, and a fixing mechanism for fixing the first holding section at a predetermined location by holding the first holding section.

In the present reference example, the pressing mechanism and the fixing mechanism may be supported by a supporting plate that is formed on the opposite side of the first holding section while interposing the second holding section between the supporting plate and the first holding section.

In the present reference example, the pressing mechanism may include a container that freely expands and contracts and covers at least the second member, and may press the second holding section by introducing a fluid into the container.

In the present reference example, the moving mechanism may be formed on a opposite side of the second holding section while the first holding section is interposed between the moving mechanism and the second holding section, and a predetermined gap may be formed between the first holding section and the moving mechanism.

In the present reference example, the bonding apparatus may include a position adjusting mechanism for controlling the moving mechanism to align the location of the first member with the second member.

In the present reference example, at least one of the first holding section and the second holding section may include a heating mechanism which heats at least one of the first member and the second member. In addition, at least one of the first holding section and the second holding section may include a cooling mechanism which cools down at least one of the first member and the second member.

According to a reference example of still another aspect, a method of bonding two members by using the bonding apparatus of the above-mentioned reference example may include: performing an alignment of locations of the first member and the second member; moving the first holding section toward the second holding section by the moving mechanism so that the first member and the second member contact each other; holding the first holding section by using the fixing mechanism; and pressing the second holding section by using the pressing mechanism.

### Advantageous Effects

According to the present invention, when two members are bonded to each other, generation of voids between the members may be prevented and the bonding operation may be performed efficiently.

### BRIEF DESCRIPTION OF THE DRAWINGS

FIG. 1 is a schematic longitudinal-sectional view showing a configuration of a bonding apparatus according to an embodiment;

FIG. 2 is a schematic longitudinal-sectional view showing a configuration of the bonding apparatus according to an embodiment;

FIG. 3 is a schematic plan view showing a configuration around a lower chuck;

FIG. 4 is a schematic plan view showing a configuration of a height adjusting mechanism;

FIG. 5 is a schematic side view showing a configuration of the height adjusting mechanism;

FIG. 6 is a diagram illustrating a relationship between an eccentric roll and a rotating shaft;

FIG. 7 is a schematic diagram illustrating a groove in a protrusion;

FIG. 8 explains a pressure distribution on a surface of a wafer when the wafer is pressed by a pressure container, in which FIG. 8(a) is a diagram showing an in-plane pressure distribution when the diameter of the pressure container is equal to the diameter of the wafer, and FIG. 8(b) is a diagram showing an in-plane pressure distribution when the diameter of the pressure container is greater than the diameter of the wafer;

FIG. 9 is a schematic side view showing a configuration of the bonding apparatus;

FIG. 10 is a diagram explaining a state in which a lower chuck and an upper chuck are separated from each other;

FIG. 11 is a diagram explaining a state in which the lower chuck is ascended;

FIG. 12 is a diagram explaining a state in which a center portion of the upper chuck bends;

FIG. 13 is a diagram explaining a state in which the entire surface of a glass substrate abuts on the entire surface of a wafer;

FIG. 14 is a diagram explaining displacement contour for a vertical location of the glass substrate in a state where the center portion of the glass substrate abuts on the wafer;

FIG. 15 is a diagram explaining a state where the glass substrate and the wafer are bonded to each other;

FIG. 16 is a schematic longitudinal-sectional view showing a configuration of a bonding apparatus including a heating mechanism and a cooling mechanism;

FIG. 17 is a schematic longitudinal-sectional view showing a configuration of a bonding apparatus including a position adjusting mechanism;

FIG. 18 is a diagram explaining a state where the center of a metal film as a target and the center of an image captured by a lower imaging unit are matched with each other;

FIG. 19 is a diagram explaining a state where reference points of the glass substrate are marked on the image captured by the lower imaging unit;

FIG. 20 is a diagram explaining a state where the center of the metal film as the target and the center of an image captured by an upper imaging unit are matched with each other;

FIG. 21 is a diagram explaining a state where locations of the reference points marked on the image captured by the upper imaging unit and locations of the reference points marked on the image captured by the lower imaging unit are matched with each other;

FIG. 22 is a schematic longitudinal-sectional view showing a configuration of a bonding apparatus according to another embodiment of the present invention; and

FIG. 23 is a schematic longitudinal-sectional view showing a configuration of a bonding apparatus according to another embodiment of the present invention.

### EXPLANATION ON REFERENCE NUMERALS

1: bonding apparatus
10: lower chuck
11: upper chuck
12: rotating table
20: moving mechanism
21: rotating portion
22: vertical moving portion
23: horizontal moving portion
30: protrusion
40: height adjusting mechanism
50: sealing member
52: intake pipe
70: pressing mechanism
71: pressure container
73: supporting plate
80: fixing mechanism
90: heating mechanism
91: cooling mechanism
100: position adjusting mechanism
110: fixing mechanism
D: gap
G: glass substrate
S: bonding space
W: wafer

### BEST MODE FOR CARRYING OUT THE INVENTION

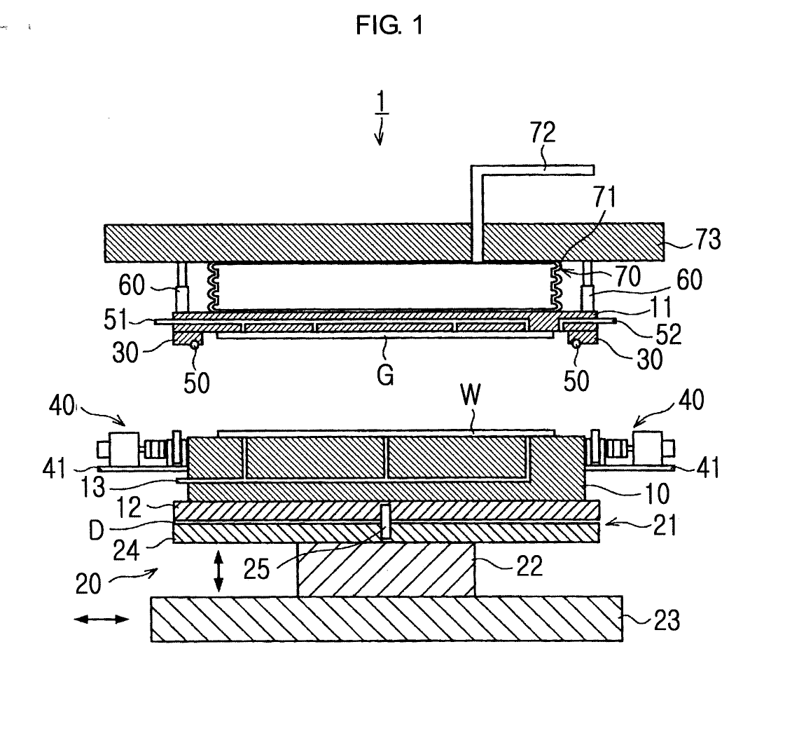

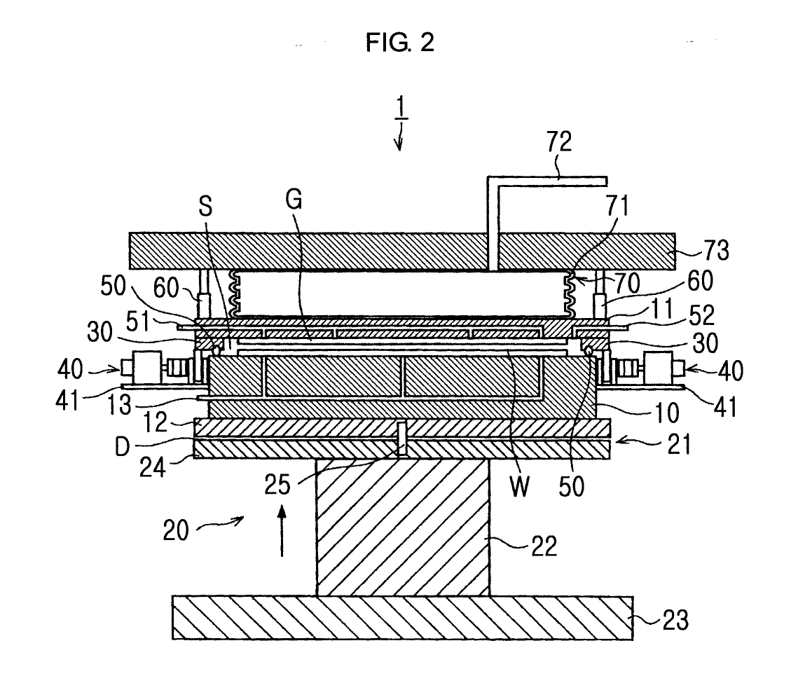

Hereinafter, embodiments of the present invention will be described as follows. FIGS. 1 and 2 are schematic longitudinal-sectional views showing a configuration of a bonding apparatus 1 according to an embodiment of the present invention.

The bonding apparatus 1 includes a lower chuck 10 as a part of a first holding section that places and holds a wafer W, that is, a first member, on an upper surface thereof, and an upper chuck 11 as a second holding section that adsorbs and holds a glass substrate G, that is, a second member, on a lower surface thereof. The upper chuck 11 is formed above and facing the lower chuck 10. That is, the wafer W held by the lower chuck 10 and the glass substrate G held by the upper chuck 11 face each other. A rotating table 12 that supports the lower chuck 10 and freely rotates in a horizontal direction is formed on a lower surface of the lower chuck 10. In addition, the lower chuck 10 and the rotating table 12 form the first holding section. Also, in the present embodiment, the wafer W and the glass substrate G are formed, for example, as thin plate shape having the same diameter, and are bonded to each other by, for example, an adhesive. The first holding section is not limited to the above embodiment, provided that it may hold the wafer W.

A suction pipe 13 for adsorbing and holding the wafer W is formed inside the lower chuck 10. The suction pipe 13 is connected to a negative pressure generating apparatus, for example, a vacuum pump (not shown). The lower chuck 10 is formed of a material, for example, a ceramic material such as silicon carbide ceramic or aluminum nitride ceramic, having a sufficient rigidity not to be deformed even when a load is applied by a pressing mechanism 70 that will be described later.

A moving mechanism 20 is formed on the lower side of the lower chuck 10 and the rotating table 12. The moving mechanism 20 moves the rotating table 12, the lower chuck 10, and the wafer W in a vertical direction and a horizontal direction, and also rotates the rotating table 12, the lower chuck 10, and the wafer W in the horizontal direction. The moving mechanism 20 may three-dimensionally move the rotating table 12 with an accuracy of, for example, ±1 μm unit. The moving mechanism 20 includes a rotating portion 21 for rotating the rotating table 12 in the horizontal direction, a vertical moving portion 22 for moving the rotating table 12 in the vertical direction, and a horizontal moving portion 23 for moving the rotating table 12 in the horizontal direction. The rotating portion 21, the vertical moving portion 22, and the horizontal moving portion 23 are provided in this order from the upside of moving mechanism.

The rotating portion 21 includes a pedestal 24 for rotating the rotating table 12. A rotary shaft 25 is formed between the rotating table 12 and the pedestal 24 and is connected to a rotating mechanism (not shown). The rotating portion 21 transfers a driving force of the rotating mechanism to the rotating table 12 so as to rotate the rotating table 12 in the horizontal direction. The rotary shaft 25 is provided so as to form a gap D of a predetermined interval between the lower surface of the rotating table 12 and an upper surface of the pedestal 24. Here, for example, when the diameter of the wafer W is 300 mm and the lower chuck 10 is formed of the above described material, a sum of flatness of the lower surface of the rotating table 12 that supports the lower chuck 10 and the upper surface of the pedestal 24 is 10 μm or less. The flatness includes a processing tolerance or deformation of the rotating table 12 and the pedestal 24. Thus, the predetermined interval, that is, the gap D is set to a value, for example, 10 μm, such that the lower surface of the rotating table 12 and the upper surface of the pedestal 24 do not contact each other. Accordingly, the rotating table 12 may rotate on the rotary shaft 25 without contacting the pedestal 24. The gap D may be actively formed by supplying air from an air supply source (not shown).

The above-mentioned moving mechanism 20 may perform alignment of location of the wafer W on the lower chuck 10, and may form a bonding space S for bonding the wafer W and the glass substrate G to each other by ascending the lower chuck 10 as shown in FIG. 2. The bonding space S is a space surrounded by the lower chuck 10, the upper chuck 11, and a protrusion 30 that protrudes downward from an outer circumferential lower surface of the upper chuck 11.

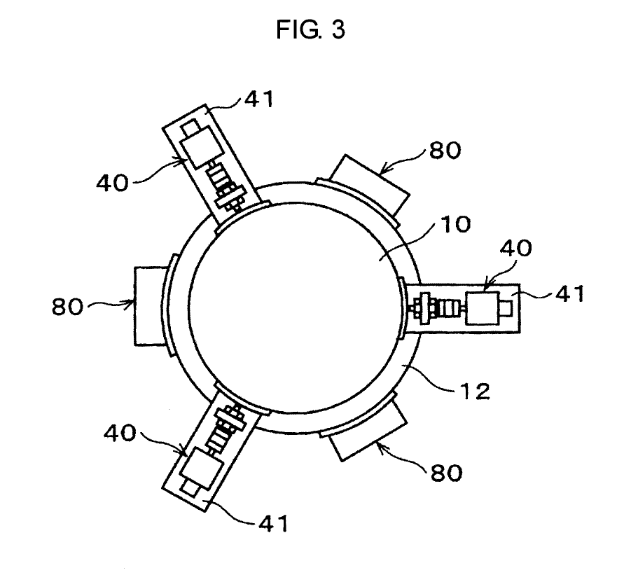

A height adjusting mechanism 40 is formed on a side surface of the lower chuck 10 and is capable of adjusting a vertical distance between the wafer W and the glass substrate G in the bonding space S by supporting the protrusion 30 and adjusting the height of the upper chuck 11. The height adjusting mechanism 40 is supported by a supporter 41 that is formed on the side surface of the lower chuck 10. The height adjusting mechanism 40 is disposed to be located on an outer side of a sealing member 50 that will be described later, when abutting on the protrusion 30. The height adjusting mechanism 40 may be formed at a plurality of positions, for example, at three positions as shown in FIG. 3, and disposed with equal intervals along the side surface of the lower chuck 10. The number of the height adjusting mechanism 40 is not limited to the present embodiment, and may be three or more.

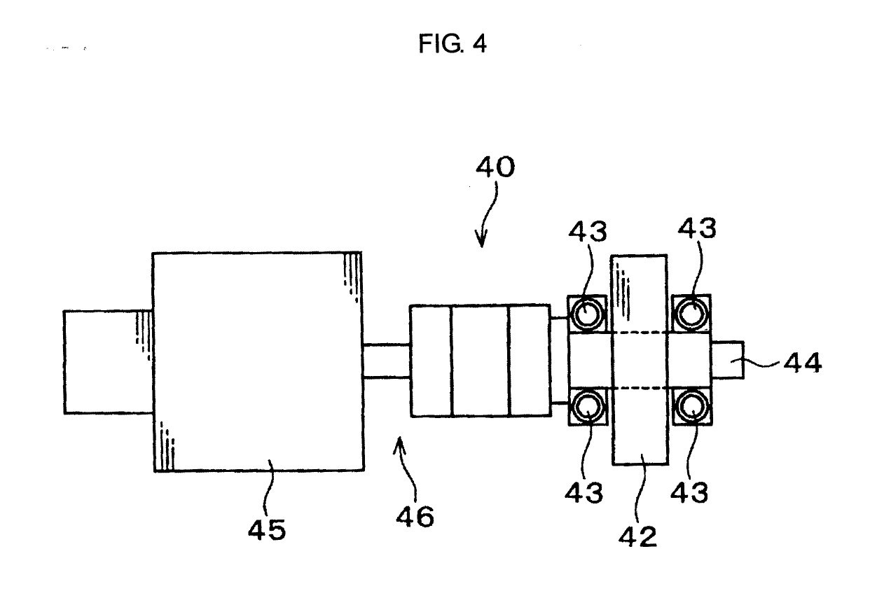

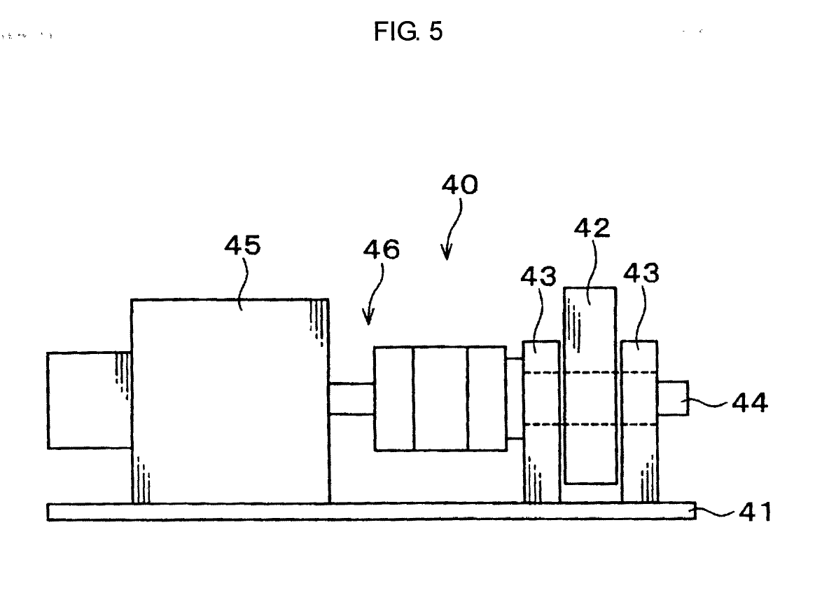

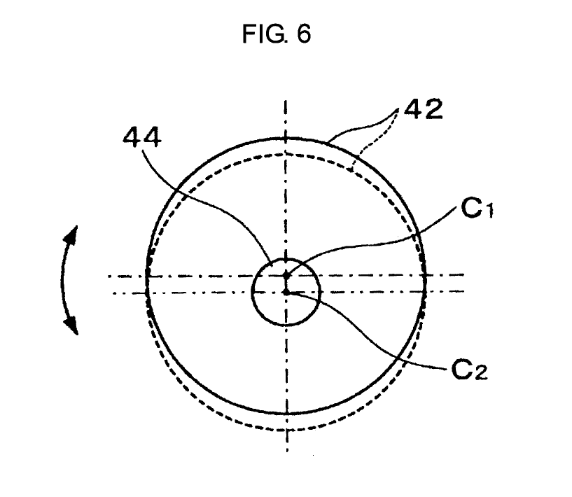

The height adjusting mechanism 40 has an eccentric roll 42, as shown in FIGS. 4 and 5. The eccentric roll 42 is supported by a supporting frame 43 formed on the supporter 41. A rotary shaft 44 for rotating the eccentric roll 42 is inserted and penetrates eccentric roll 42. A rotating driver 46 having a motor 45, for example, is connected to the rotary shaft 44 so that the rotary shaft 44 is rotated by the rotating driver 46. A center C₁ of the eccentric roll 42 is eccentric to a center C₂ of the rotary shaft 44, as shown in FIG. 6. Therefore, the height adjusting mechanism 40 may adjust the height of the upper chuck 11, by rotating the rotary shaft 44 and adjusting the vertical height of the top point of the eccentric roll 42, that is, the height of a contact point with the protrusion 30.

The upper chuck 11 may be formed of an elastic material, for example, aluminum. The upper chuck 11 is configured such that one part of the upper chuck 11, for example, a center portion of the upper chuck 11, bends when a predetermined pressure, for example, 0.7 atm (=0.07 MPa), is applied to an entire surface of the upper chuck 11 as will be described later. As described above, in order to make the center portion of the upper chuck 11 bent, the thickness of the upper chuck 11 is determined by an analysis using a finite element method, for example. For example, according to an analysis on the conditions that the diameter of the glass substrate G is 300 mm and the diameter of the sealing member 50 that is formed on the lower surface side of the upper chuck 11 as will be described later is 306 mm, it can be seen that the center portion of the upper chuck 11 bends when the thickness of the upper chuck 11 is 16 mm. In addition, when the center portion of the upper chuck 11 bends, the center portion of the glass substrate G held by the upper chuck 11 is required to contact the wafer W, as will be described later. Thus, the upper chuck 11 is formed so that the bent center portion thereof is equal to or greater than the vertical distance between the glass substrate G and the wafer W in the bonding space S. Here, for example, when a sum of thicknesses of the glass substrate G and the wafer W, which are bonded to each other, is set as 1.2 mm, the height of the protrusion 30 is set as 0.9 mm, and the vertical distance between the protrusion 30 and the lower chuck 10 in the bonding space S is set as 0.5 mm, the vertical distance between the glass substrate G and the wafer W is 0.2 mm. In this point of view, according to the above described analysis result, if the thickness of the upper chuck 11 is 16 mm, the amount of bending on the center portion of the upper chuck 11 is 0.2 mm so that the center portion of the glass substrate G abuts on the wafer W.

The protrusion 30 is formed on the outer circumferential lower surface of the upper chuck 11 to protrude downward from the outer circumferential lower surface thereof as shown in FIG. 2. The protrusion 30 is formed along the outer circumference of the upper chuck 11. The upper chuck 11 and the protrusion 30 may be integrally formed.

The sealing member 50 for holding an air-tightness of the bonding space S is formed on a lower surface of the protrusion 30. The sealing member 50 is formed in a circular shape in a groove formed in the lower surface of the protrusion 30, and may be, for example, an O-ring. The sealing member 50 has elasticity. The sealing member 50 is not limited to the present embodiment, provided that it is a component having a sealing function. In the present embodiment, an air-tight holding mechanism is formed of the protrusion 30, the sealing member 50, and the height adjusting mechanism 40.

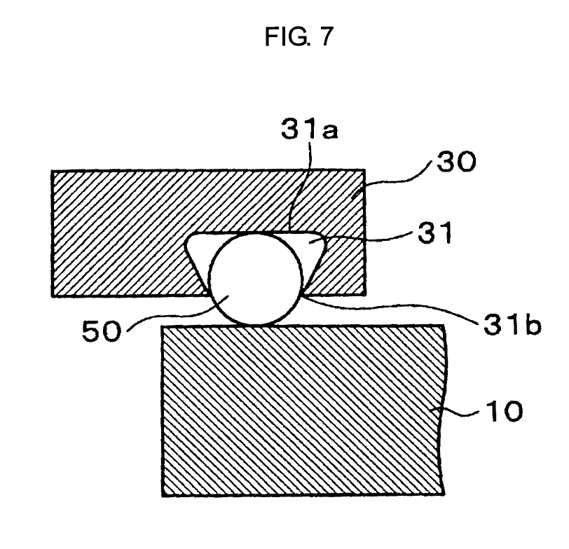

As shown in FIG. 7, a groove 31 formed in the lower surface of the protrusion 30 has a substantially taper-shaped cross-section, in which the width of an upper end portion 31a of the groove is greater than the width of a lower end portion 31b. The depth of the groove 31 is formed such that an upper end of the sealing member 50 abuts on the upper end portion 31a of the groove 31 to hold the air-tightness of the bonding space S when the bonding space S is formed as shown in FIG. 2. A cross-sectional area of the groove 31 is equal to or greater than a cross-sectional area of the sealing member 50, so that the elastically deformed sealing member 50 may be received in the groove 31. Since the groove 31 has the substantially tapered cross-section, the groove 31 may catch the sealing member 50 at the lower end portion 31b thereof, and thus, the sealing member 50 does not fall from the protrusion 30.

A suction pipe 51 for adsorbing and holding the glass substrate G as shown in FIG. 2 is formed inside the upper chuck 11. The suction pipe 51 is connected to a negative pressure generating apparatus such as a vacuum pump (not shown).

An intake pipe 52 for intaking the atmosphere in the bonding space S is formed inside the upper chuck 11. One end of the intake pipe 52 is opened at the lower surface of the upper chuck 11 where the glass substrate G is not held. The other end of the intake pipe 52 is connected to a negative pressure generating apparatus, for example, a vacuum pump (not shown). An intake mechanism of the present embodiment includes the intake pipe 52 and the negative pressure generating apparatus connected to the intake pipe 52.

A supporting member 60 for supporting the upper chuck 11 and a pressing mechanism 70 for pressing down the upper chuck 11 in the vertical direction are formed on the upper surface of the upper chuck 11. The pressing mechanism 70 includes a pressure container 71 formed to cover the glass substrate G and the wafer W, and a fluid supply pipe 72 for supplying fluid, for example, compressed air, to an inner side of the pressure container 71. The supporting member 60 is configured to freely expand and contract in the vertical direction, and may be formed, for example, at three positions on the outer side of the pressure container 71.

The pressure container 71 is formed of a material that may freely expand and contract in the vertical direction, for example, a stainless bellows. A lower surface of the pressure container 71 abuts on the upper surface of the upper chuck 11, and an upper surface of the pressure container 71 abuts on a lower surface of a supporting plate 73 that is formed above the upper chuck 11. One end of the fluid supply pipe 72 is connected to the pressure container 71, and the other end of the fluid supply pipe 72 is connected to a fluid supply source (not shown). When a fluid is supplied from the fluid supply pipe 72 to the pressure container 71, the pressure container 71 expands. At this time, since the upper surface of the pressure container 71 and the lower surface of the supporting plate 73 contact each other, the pressure container 71 expands downwards only so as to press the upper chuck 11, which is formed under the lower surface of the pressure container 71, to the lower side. Since the inside of the pressure container 71 is pressed by the fluid, the pressure container 71 may evenly press the plane of the upper chuck 11. A load generated when the upper chuck 11 is pressed may be adjusted by controlling the pressure of the compressed air supplied into the pressure container 71. The supporting plate 73 may be formed of a member having a sufficient rigidity so as not to be deformed by a repulsive force against the load applied to the upper chuck 11 by the pressing mechanism 70.

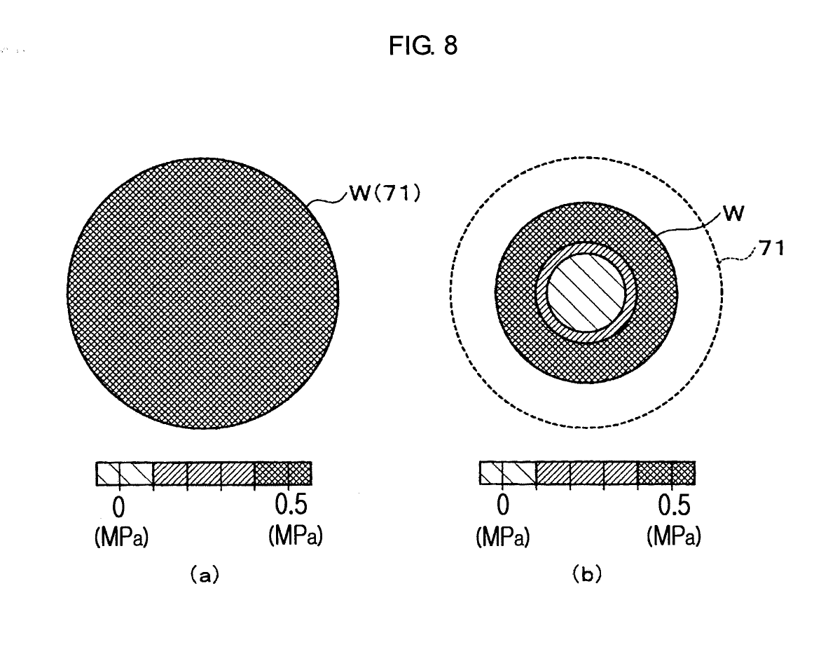

In addition, the above description that the pressure container 71 covers the glass substrate G and the wafer W means that, for example, the diameter of the pressure container 71 is equal to the diameter of the glass substrate G and the diameter of the wafer W. The diameter of the pressure container 71 denotes the diameter of a portion of the pressure container 71 abutting on the upper chuck 11. According to a search result by the present inventors, as shown in FIG. 8A, in a case where the diameters of the pressure container 71 and the wafer W are equally 300 mm, it could be found that, when the pressure container 71 presses the upper chuck 11 with a pressure of 0.5 MPa, the pressure is evenly distributed in the plane of the wafer W. In the present embodiment, since the diameter of the pressure container 71 is equal to the diameters of the glass substrate G and the wafer W as shown in FIG. 2, the in-plane pressure distribution of the glass substrate G and the wafer W becomes uniform.

On the other hand, as shown in FIG. 8(b), in a case where the diameter of the pressure container 71 is 300 mm and the diameter of the wafer W is 200 mm, that is, the diameter of the pressure container 71 is greater than that of the wafer W, when the pressure container 71 presses the upper chuck 11 with a pressure of 0.5 MPa, the pressure is unevenly distributed in the plane of the wafer W, and thus, the pressure applied to the outer circumferential portion of the wafer W becomes greater than the pressure applied to the center portion of the wafer W. This may be because, when the pressure container 71 presses the upper chuck 11, the upper chuck 11 bends to bulge upward due to the space existing on the outer side of the wafer W. Thus, in this case, a ring-shaped spacer may be formed in a space outside the wafer W. That is, the spacer may be formed outside the wafer W and the glass substrate G. The spacer has an outer circumferential diameter that is equal to the diameter of the pressure container 71, and has a thickness that is equal to a sum of the thicknesses of the glass substrate G and the wafer W bonded to each other. In this case, the pressure from the pressure container 71 is evenly applied to the spacer, the glass substrate G, and the wafer W, and thus, the in-plane pressure distribution becomes even in the glass substrate G and the wafer W.

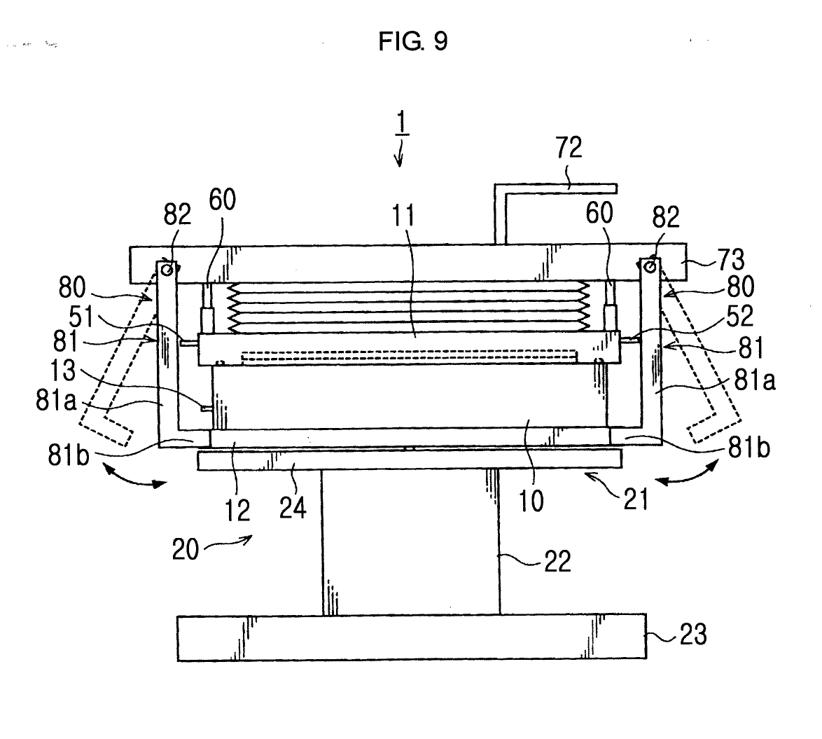

As shown in FIG. 9, a fixing mechanism 80 is formed on the supporting plate 73 and holds the rotating table 12 to fix the lower chuck 10 on the rotating table 12 to the desired vertical location. The fixing mechanism 80 may be formed at a plurality of positions, for example, at three positions, as shown in FIG. 3, with equal intervals along the outer circumference of the rotating table 12. The number of the fixing mechanism 80 is not limited to the present embodiment, but preferably is three or more.

As shown in FIG. 9, the fixing mechanism 80 includes a clamp 81 for holding the rotating table 12, and a supporting pin 82 which is slidably connecting the clamp 81 and the supporting plate 73 to each other. The clamp 81 includes a main body 81a that is elongated from the supporting pin 82, and a holding portion 81b which is formed on the front end of the main body 81 and holds the rotating table 12. The main body 81a is formed to a length, by which the holding portion 81b may hold the rotating table 12 when the lower chuck 10 is ascended to form the bonding space S between the lower chuck 10 and the upper chuck 11. The clamp 81 is configured to freely pivot on the supporting pin 82 by a driving mechanism (not shown).

When the pressing mechanism 70 presses the upper chuck 11, the fixing mechanism 80 holds the rotating table 12 so as to fix the location of the rotating table 12. Accordingly, when the pressing mechanism 70 presses the upper chuck 11 downward, the load may be prevented from being transferred to the moving mechanism 20 that is formed under the rotating table 12. The fixing mechanism 80 may be configured to hold the lower chuck 10, for example, besides the rotating table 12, provided that it may prevent the load of the pressing mechanism 70 from being transferred to the moving mechanism 20.

The bonding apparatus 1 according to the present embodiment has the above described structure. Hereafter, a bonding method for bonding the wafer W and the glass substrate G to each other performed in the bonding apparatus 1 will be described as follows. In the present embodiment, an adhesive is in advance applied on at least one surface of the upper surface of the wafer W and the lower surface of the glass substrate G.

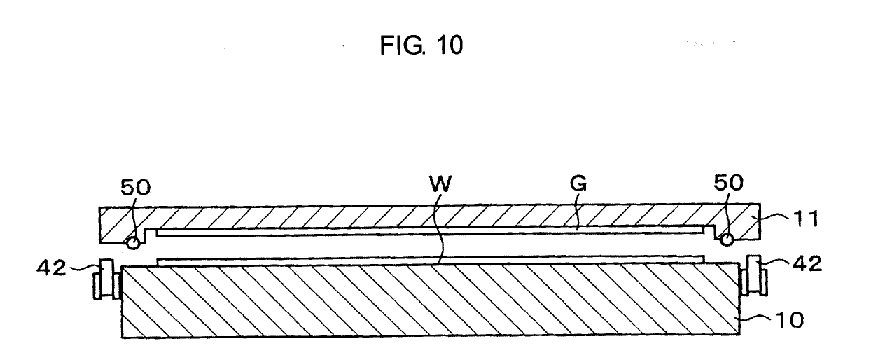

To begin with, as shown in FIG. 10, the wafer W is placed and held on the lower chuck 10 and the glass substrate G is adsorbed and held on the upper substrate 11, in a state where the lower chuck 10 and the upper chuck 11 are separated from each other. The location of the lower chuck 10 is adjusted by the moving mechanism 20 so that the wafer W faces the glass substrate G. A pressure between the upper chuck 11 and the glass substrate G may be, for example, 0.1 atm (=0.01 MPa). The pressure applied to the upper surface of the upper chuck 11 is 1.0 atm (=0.1 MPa) that is the atmospheric pressure. In order to maintain the atmospheric pressure applied to the upper surface of the upper chuck 11, the pressure in the pressure container 71 of the pressing mechanism 70 may be set as the atmospheric pressure, or a gap may be formed between the upper surface of the upper chuck 11 and the pressure container 71.

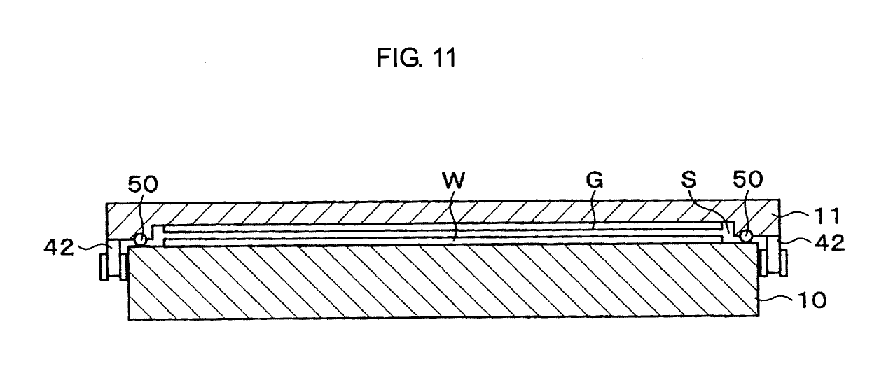

Next, the lower chuck 10 is ascended by the moving mechanism 20 until the eccentric roll 42 of the height adjusting mechanism 40 abuts on the protrusion 30, as shown in FIG. 11. Here, the height of the contact point between the eccentric roll 42 and the protrusion 30 is set such that the vertical distance between the wafer W and the glass substrate G may become a predetermined distance. The predetermined distance is equal to a height at which the center portion of the glass substrate G abuts on the wafer W when the sealing member 50 abuts on the lower chuck 10 and the center portions of the upper chuck 11 and the glass substrate G are bent, as will be described later. Through the above processes, the bonding space S that is sealed is formed between the lower chuck 10 and the upper chuck 11. The location of the lower chuck 10 is fixed by the clamp 81 of the fixing mechanism 80.

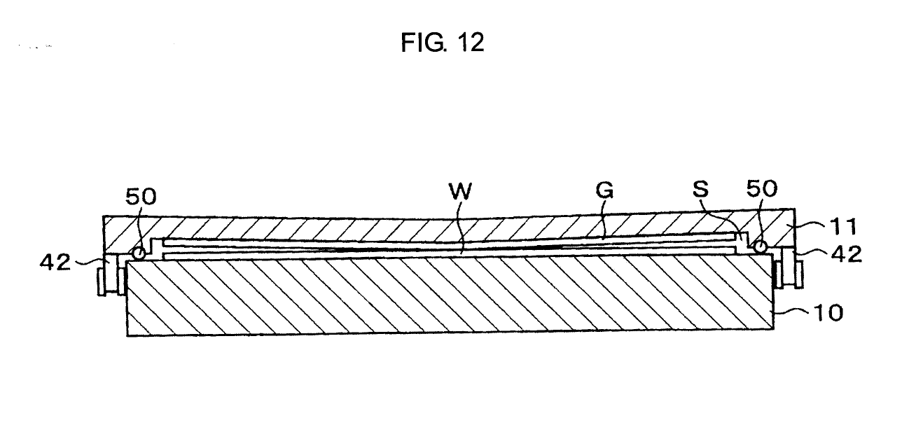

After that, the intake pipe 52 intakes the atmosphere in the bonding space S. In addition, when the bonding space S is depressurized to, for example, 0.3 atm (=0.03 MPa), a difference between the pressure applied to the upper surface of the upper chuck 11 and the pressure in the bonding space S, that is, 0.7 atm (=0.07 MPa), is applied to the upper chuck 11. Then, as shown in FIG. 12, the center portion of the upper chuck 11 bends, and thus, the center portion of the glass substrate G held by the upper chuck 11 is also bent. Even when the bonding space S is depressurized to 0.3 atm (=0.03 MPa), the pressure between the upper chuck 11 and the glass substrate G is 0.1 atm (=0.01 MPa), and thus, the holding status of the glass substrate G by the upper chuck 11 is maintained.

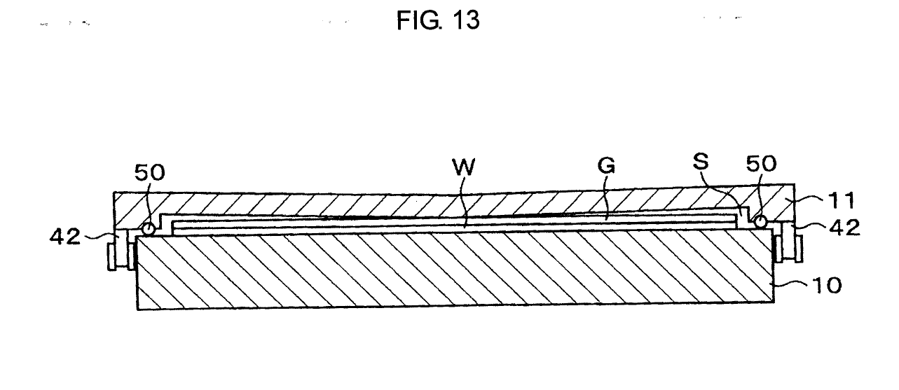

After that, the atmosphere in the bonding space S is additionally taken in to depressurize the bonding space S. In addition, when the bonding space S is 0.1 atm (=0.01 MPa) or less, the upper chuck 11 cannot hold the glass substrate G, and thus, the glass substrate G falls down as shown in FIG. 13 and the entire surface of the glass substrate G abuts on the entire surface of the wafer W. At this time, the glass substrate G sequentially abuts on the wafer W from the center portion contacting the wafer W toward a radial direction outer side of the glass substrate G, and then, the glass substrate G and the wafer W are bonded to each other by the adhesive.

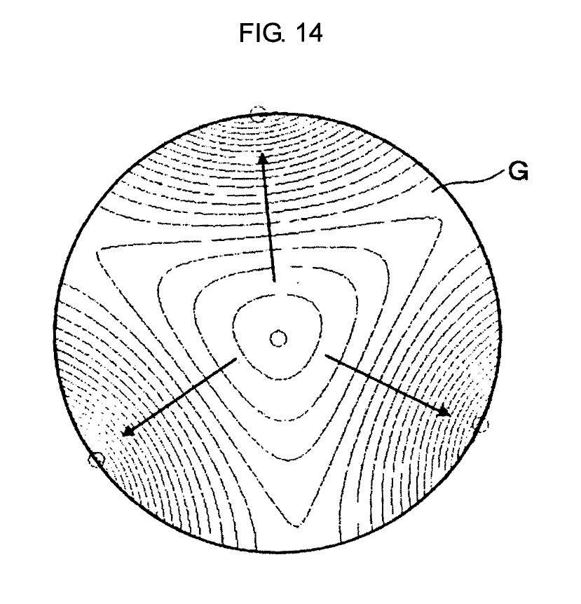

Here, the present inventors performed a simulation by using the bonding apparatus 1 according to the present embodiment in order to conduct a search on a status of the glass substrate G abutting on the wafer W. The simulation result is shown in FIG. 14. Lines on the glass substrate G of FIG. 14 are isopleth lines representing dislocation of the glass substrate G in the vertical direction. FIG. 14 shows a status that the center portion of the glass substrate G abuts on the wafer W, and the vertical location of the glass substrate G is displaced sequentially in the arrow direction shown in FIG. 14, that is, from the center portion toward the radial direction outer side. Therefore, the glass substrate G sequentially abuts on the wafer W from the center portion thereof to the radial direction outer side. That is, for example, even when air that may become voids exists in the bonding space S, the air always exists outside a contacting region between the glass substrate G and the wafer W.

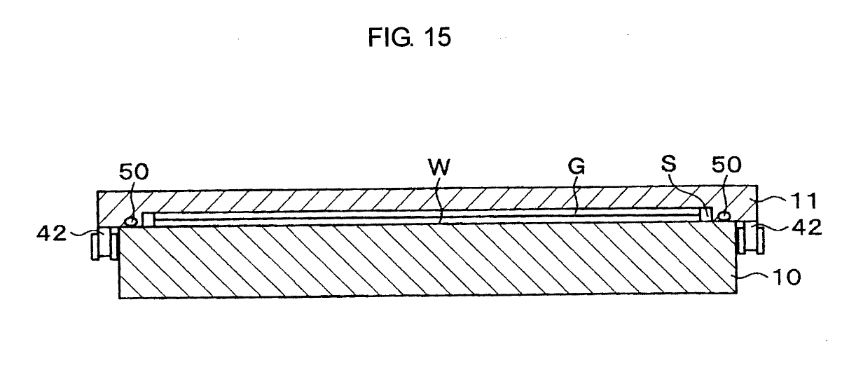

After that, as shown in FIG. 15, the height of the contact point between the eccentric roll 42 and the protrusion 30 is adjusted by the height adjusting mechanism 40 so that the lower surface of the upper chuck 11 abuts on the upper surface of the glass substrate G. At this time, the sealing member 50 is elastically deformed and received in the groove 31 of the protrusion 30, and then, closely contacts the lower chuck 10. The pressing mechanism 70 presses the upper chuck 11 downward with a predetermined pressure, for example, 0.75 MPa, and then, the glass substrate G and the wafer W are more strongly adhered and bonded to each other.

According to the above-described embodiment, the atmosphere in the bonding space S is taken in through the intake pipe 52 so that the pressure difference between the pressure applied to the upper surface of the upper chuck 11 and the pressure in the bonding space S is made, and then, by the pressure difference as predetermined pressure, the center portion of the upper chuck 11 can be bent. Then, the center portion of the glass substrate G may contact the wafer W in a state where the upper chuck 11 holds the glass substrate G. After that, the atmosphere in the bonding space S is further taken in through the intake pipe 52 so that the pressure in the bonding space S may be lower than the pressure between the upper chuck 11 and the glass substrate G. Thereby, the glass substrate G falls down from the upper chuck 11 and the entire surface of the glass substrate G may contact the entire surface of the wafer W. At this time, the glass substrate G abuts on the wafer W sequentially from the center portion thereof toward the radial direction outer side. That is, for example, even when air that may generate voids may exist in the bonding space S, the air always exists outside the contacting region between the glass substrate G and the wafer W, and thus, the air may be pushed out from the contacting portion between the wafer W and the glass substrate G. Therefore, according to the present embodiment, the glass substrate G and the wafer W may be bonded to each other while the generation of the voids between the glass substrate G and the wafer W is prevented.

When the wafer W and the glass substrate G are bonded to each other, it is enough only to intake the atmosphere of the tiny bonding space as described above without the need to perform the bonding of the members in the vacuum atmosphere like the conventional art. Moreover, the air-tightness in the bonding space S is held by the sealing member 50 formed in the lower surface of the protrusion 30. Therefore, the atmosphere of the bonding space S may be taken-in in a short time, and thus the bonding of the wafer W and the glass substrate G may be performed effectively and in a short time.

Since the center portion of the glass substrate G may contact the wafer W in a state where the glass substrate G is adsorbed and held by the upper chuck 11, the bonding of the glass substrate G and the wafer W may be appropriately performed without misalignment of location of the glass substrate G with the wafer W. In addition, since the glass substrate G is adsorbed and held by the upper chuck 11, a spacer for supporting an upper wafer like in the conventional bonding apparatus disclosed in the above-described Patent Reference 1 is not necessary, and thus, the bonding apparatus 1 may be made smaller.

Here, for example, when the moving mechanism is formed in the conventional bonding apparatus, the pressure applied to the upper chuck and the lower chuck by the pressing mechanism is transferred to the moving mechanism so that the moving mechanism may be damaged. According to the present embodiment, since the location of the lower chuck 10 is fixed by the fixing mechanism 80, even when the upper chuck 11 is pressed down by the pressing mechanism 70, the pressure is not transferred to the moving mechanism 20 formed under the lower chuck 10. Therefore, the alignment of locations of the glass substrate G and the wafer W may be achieved while protecting the moving mechanism 20.

The upper surface of the pressing mechanism 70 abuts on and is supported by the supporting plate 73 and the fixing mechanism 80 is also supported by the supporting plate 73, and thus, a repulsive force of the pressing mechanism 70 is not transferred to other members, except for the supporting plate 73, even when the pressing mechanism 70 presses the upper chuck 11. Therefore, the members in the bonding apparatus 1 are not bent, and mechanical stress caused by the repulsive force is not applied to the inside of the bonding apparatus 1.

Also, since the gap D is formed between the rotating table 12 and the pedestal 24 in the moving mechanism 20, the moving mechanism 20 may not be damaged even though the lower chuck 10 or the rotating table 12 bends due to the pressure by the pressing mechanism 70.

In the above embodiment, the upper chuck 11 is formed such that the center portion of the upper chuck 11 bends due to a predetermined pressure; however, other portions thereof may be bent. That is, when one portion of the upper chuck 11 bends due to the predetermined pressure, the glass substrate G held by the upper chuck 11 sequentially abuts on the wafer W from the bent portion toward the radial direction outer side. Then, the air existing in the bonding space S and capable of generating voids may be pushed away from the contacting region between the wafer W and the glass substrate G.

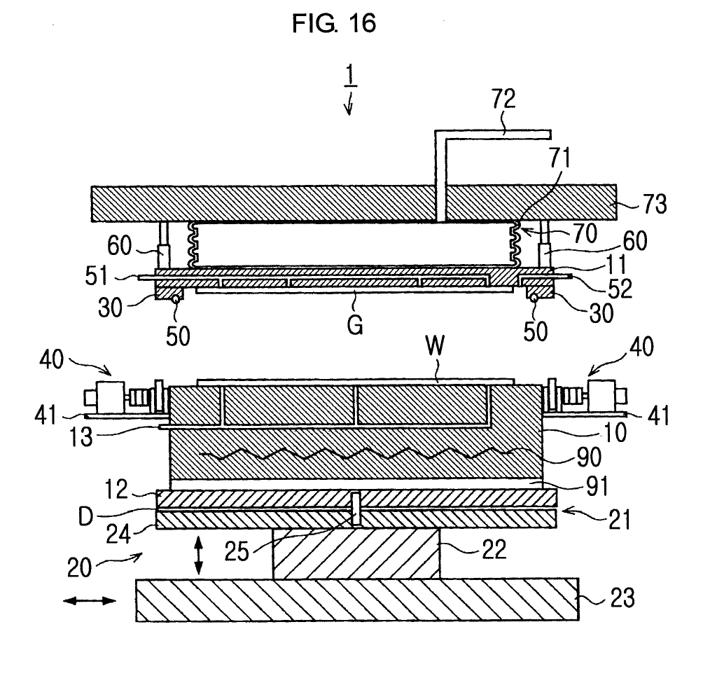

In the above embodiment, a heating mechanism 90 for heating the wafer W may be formed in the lower chuck 10, as shown in FIG. 16. The heating mechanism 90 may be a heater, for example. Here, if the adhesive for attaching the wafer W and the glass substrate G is a hot-melt type adhesive, the adhesive is required to be heated and molten at a melting point or more to be liquefied when the wafer W and the glass substrate G are bonded to each other. According to the present embodiment, before the wafer W and the glass substrate G abut on each other as shown in FIGS. 12 and 13, the adhesive on the wafer W is heated at the melting point or more by the heating mechanism 90. Then, the wafer W and the glass substrate G may be appropriately attached to each other by the adhesive. The heating mechanism 90 may be formed in the upper chuck 11 to heat the glass substrate G, and may be formed in both of the lower chuck 10 and the upper chuck 11.

A cooling mechanism 91 for cooling the wafer W down may be further formed in the lower chuck 10. The cooling mechanism 91 may be, for example, a cooling jacket formed of copper. In this case, after the wafer W and the glass substrate G are attached to each other by heating the adhesive at the melting point or more by the heating mechanism 90, the adhesive on the wafer W is cooled down to a solidification temperature or lower by the cooling mechanism 91. Then, the adhesive may be solidified rapidly after the wafer W and the glass substrate G are attached to each other, and thus, bonding of the wafer W and the glass substrate G may be effectively performed in a short time. The cooling mechanism 91 may be formed in the upper chuck 11 to cool down the glass substrate G, and may be formed in both of the lower chuck 10 and the upper chuck 11.

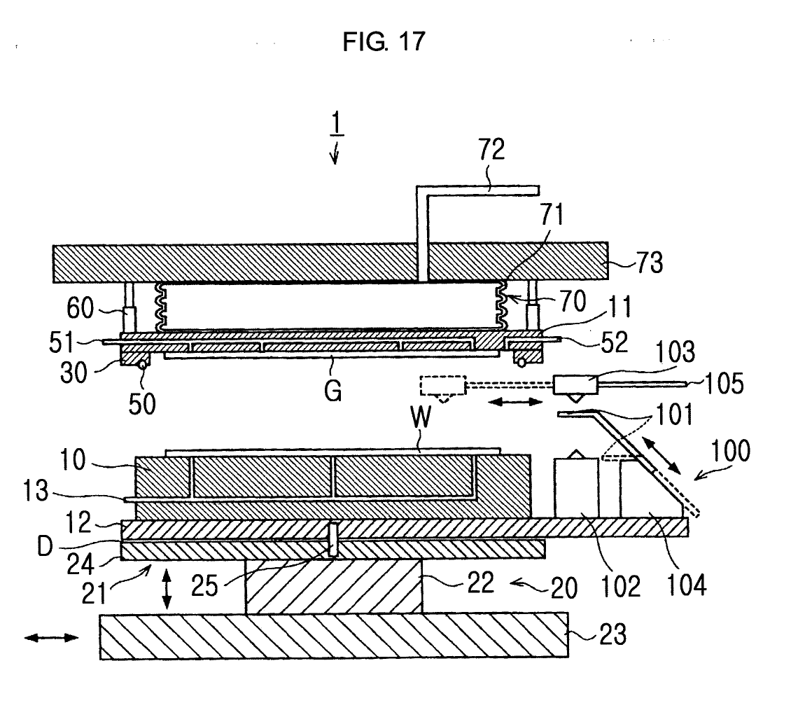

The bonding apparatus 1 according to the above embodiment may include a position adjusting mechanism 100 for controlling the moving mechanism 20 to align horizontal location of the wafer W with the glass substrate G, as shown in FIG. 17. The position adjusting mechanism 100 includes a target 101, a lower imaging unit 102 for capturing images of a lower surface of the target 101 below the target 101, and an upper imaging unit 103 for capturing images of an upper surface of the target 101 on the upper side of the target 101. The lower imaging unit 102 and the upper image unit 103 may be, for example, charged-coupled device (CCD) cameras.

The target 101 is supported by a target stage 104 that is formed on the rotating table 12. The target 101 may be, for example, a circular metal film deposited on a glass plate, which may be image-recognized by the upper imaging unit 103 and the lower imaging unit 102. The target 101 is movable in a vertically inclined direction by a driving mechanism (not shown) formed on the target stage 104, and may be retracted to a position denoted by a dashed line in FIG. 17.

The lower imaging unit 102 is formed on the rotating table 12. The lower imaging unit 102 is arranged in advance such that a center position of the image captured by the lower imaging unit 102 and a center position of the metal film of the target 101 may be matched with each other in a state where the target 101 is moved to the uppermost portion (denoted by a solid line in FIG. 17).

The upper imaging unit 103 is disposed above the target 101. A horizontal transfer mechanism 105 for moving the upper imaging unit 103 in the horizontal direction is formed on the upper imaging unit 103. The upper imaging unit 103 is movable to the upper side (a dashed line portion in FIG. 17) of the wafer W by the horizontal transfer mechanism 105.

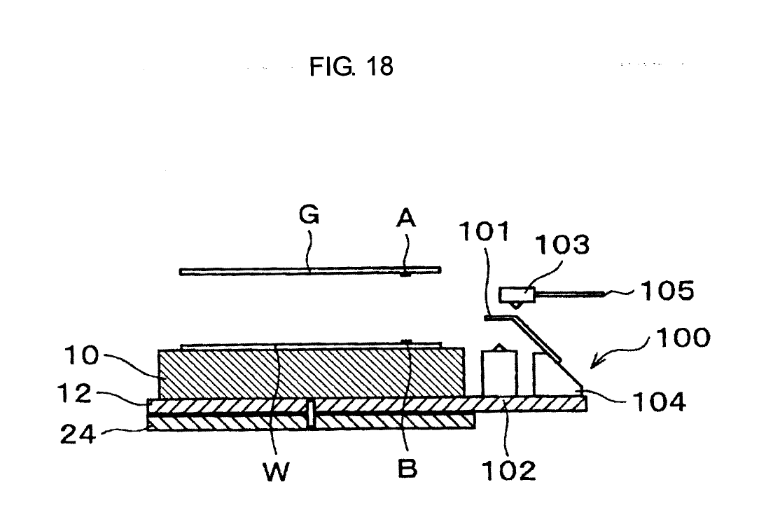

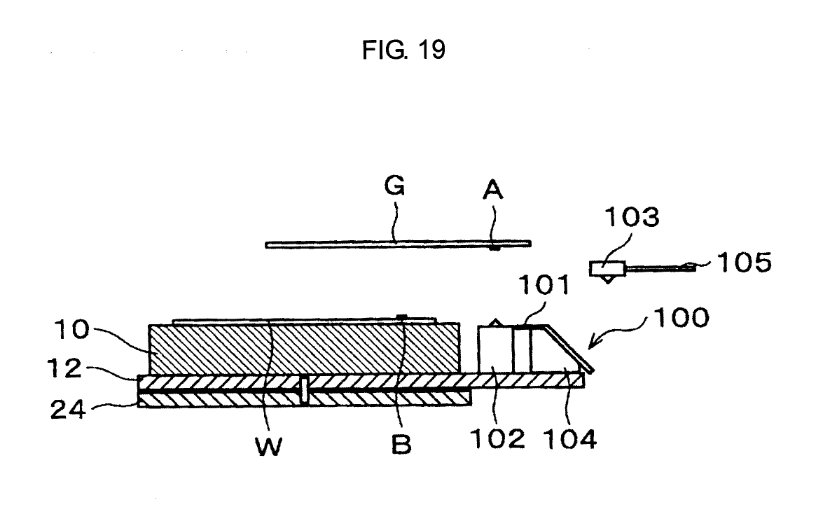

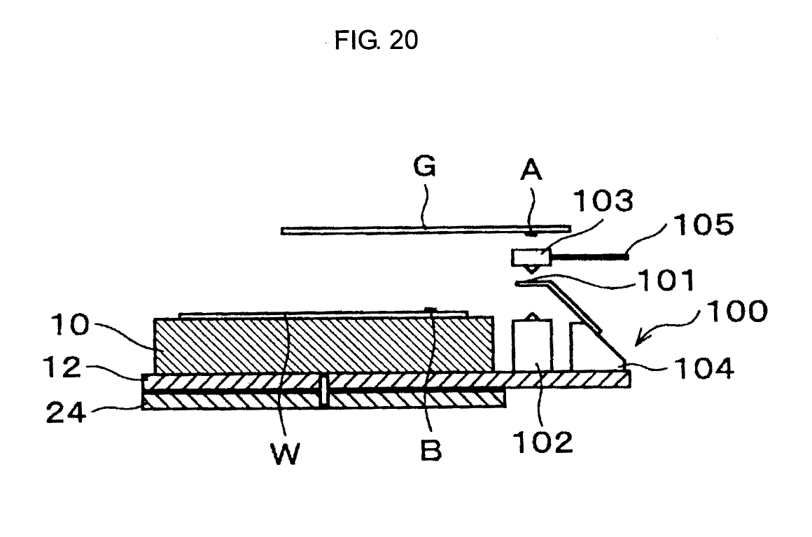

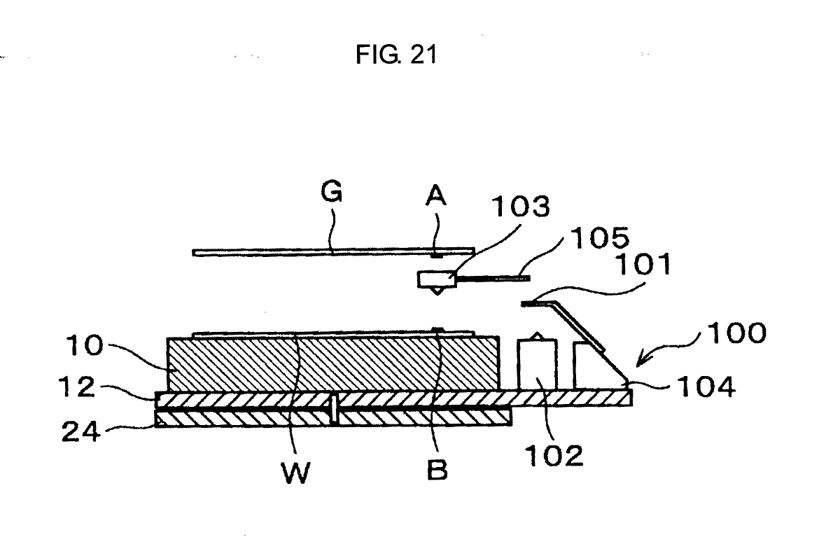

When the horizontal locations of the glass substrate G and the wafer W are adjusted by using the position adjusting mechanism 100, the locations of a plurality of reference points A that are marked on the glass substrate G in advance and the locations of a plurality of reference points B that are marked on the wafer W in advance are matched with each other in the horizontal direction. In more detail, as shown in FIG. 18, the target 101 is moved to an upper side of the lower imaging unit 102, and then, the location of the target 101 is adjusted so that the center of the metal film of the target 101 that is captured may be matched with the center of the image captured by the lower imaging unit 102. And then, as shown in FIG. 19, the target 101 is retracted from the upper side of the lower imaging unit 102, and the lower imaging unit 102 is moved to the lower side of the glass substrate G by the moving mechanism 20. After that, the location of the lower imaging unit 102 is adjusted by the moving mechanism 20 so that the plurality of reference points A that are marked on the glass substrate G in advance may be marked on the image captured by the lower imaging unit 102. Next, in this state, the target 101 is moved to the upper side of the lower imaging unit 102, and the center of the metal film of the target 101 and the center of the image captured by the lower imaging unit 102 are matched to each other. Further, as shown in FIG. 20, the upper imaging unit 103 is moved to the upper side of the target 101, and the location of the upper imaging unit 103 is adjusted by the horizontal transfer mechanism 105 so that the center of the metal film of the target 101 and a center of the image captured by the upper imaging unit 103 are matched with each other. After that, as shown in FIG. 21, the wafer W is moved to the lower side of the upper imaging unit 103 by the moving mechanism 20. And then, the location of the wafer W is adjusted by the moving mechanism 20 so that the locations of the plurality of reference points B marked on the image captured by the upper imaging unit 103 and the locations of the plurality of reference points A marked on the image captured by the lower imaging unit 102 in advance are matched with each other. Accordingly, the location alignment of the glass substrate G and the wafer W is finished. In this case, the alignment of horizontal locations of the glass substrate G and the wafer W may be accurately performed, and thus, the bonding of the wafer W and the glass substrate G can be appropriately performed.

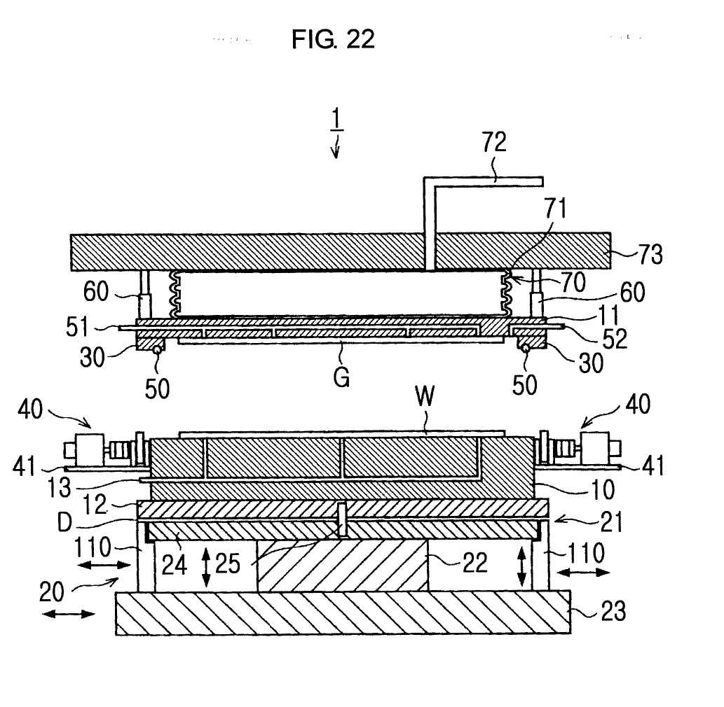

In the above embodiment, the location of the lower chuck 10 in the vertical direction is fixed by the fixing mechanism 80 having the clamp structure; however, the shape of the fixing mechanism 80 is not limited to the above embodiment. For example, a fixing mechanism 110 shown in FIG. 22 may be formed instead of the fixing mechanism 80. The fixing mechanism 110 may be formed, for example, at three positions on the horizontal moving portion 23. The fixing mechanism 110 is configured to freely move in the horizontal direction and freely expand and contract in the vertical direction on the horizontal moving portion 23.

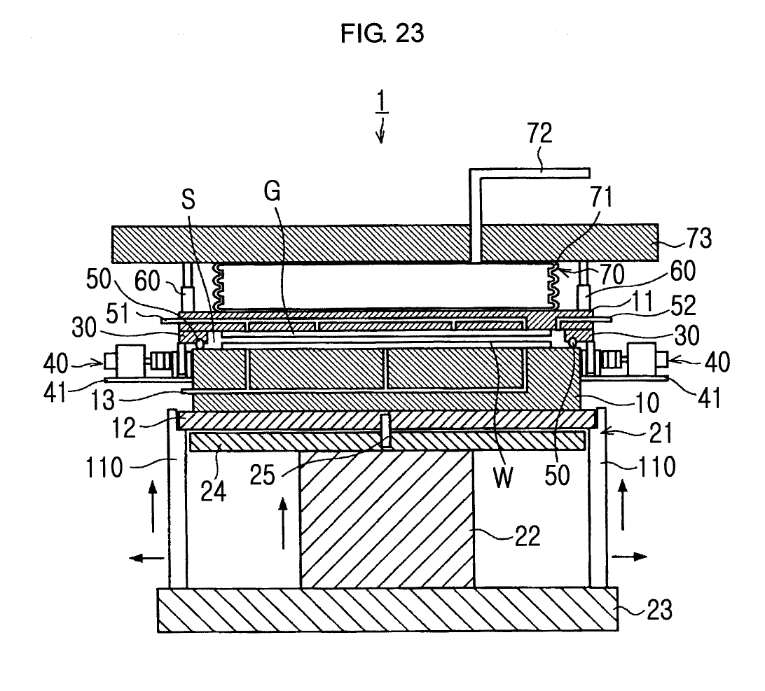

In addition, until the upper chuck 11 is pressed by the pressing mechanism 70 as shown in FIGS. 10 through 13, the fixing mechanism 110 does not contact the rotating table 12 and stands by on the horizontal moving portion 23 as shown in FIG. 22. After that, when the pressing mechanism 70 presses the upper chuck 11 as shown in FIG. 15, the fixing mechanism 110 moves to an outer side in the horizontal direction, expands in the vertical direction and supports the outer circumferential portion of the rotating table 12 as shown in FIG. 23. As described above, since the vertical location of the rotating table 12 is fixed by the fixing mechanism 110, the load may not be transferred to the moving mechanism 20 that is formed under the rotating table 12 even when the pressing mechanism 70 presses the upper chuck 11 downward.

In the above embodiment, the wafer W and the glass substrate G are bonded to each other by using the bonding apparatus 1; however, the bonding apparatus 1 of the present embodiment may be used to bond a wafer and another wafer to each other. In addition, the bonding apparatus 1 may be used to bond wafers to each other or chips to each other, when a semiconductor device is laminated three-dimensionally. In addition, the bonding apparatus 1 may be used even when a bonding member is a member such as an FPD (flat panel display) or mask retile for photomask, other than the wafer.

While the present invention has been particularly shown and described above with reference to the above specific embodiments with reference to accompanying drawings, it will be understood that various changes in form and details may be made therein without departing from the spirit and scope of the invention.

### INDUSTRIAL APPLICABILITY

The present invention is useful when two members having thin plate shapes are bonded to each other.

1. A bonding apparatus for bonding two members to each other, the bonding apparatus comprising:
a first holding section that places and holds a first member on an upper surface thereof;
a second holding section which is formed above and facing the first holding section and holds a second member on a lower surface thereof; and
an intake mechanism which sucks atmosphere between the first holding section and the second holding section,
wherein the second holding section is an elastic body, a portion of which bends due to a predetermined pressure.

2. The bonding apparatus of claim 1, further comprising an air-tight holding mechanism which holds air-tightness of a space between the first holding section and the second holding section.

3. The bonding apparatus of claim 2, wherein the air-tight holding mechanism comprises:
a protrusion which is formed along an outer circumferential lower surface of the second member and protrudes downward from the outer circumferential lower surface of the second member;
a sealing member which is formed in a circular shape on a lower surface of the protrusion and holds air-tightness of a space surrounded by the first holding section, the second holding section, and the protrusion; and
a height adjusting mechanism which is formed on an outer side of the sealing member and abuts on the lower surface of the protrusion to adjust a vertical distance between the first member and the second member.

4. The bonding apparatus of claim 3, wherein the sealing member has elasticity.

5. The bonding apparatus of claim 1, further comprising a moving mechanism which moves the first holding section in the vertical direction and in a horizontal direction, and rotates the first holding section in the horizontal direction.

6. The bonding apparatus of claim 5, wherein the moving mechanism is formed on a lower side of the first holding section, and a predetermined vertical gap is formed between the first holding section and the moving mechanism.

7. The bonding apparatus of claim 5, further comprising:
a pressing mechanism which is formed on an upper surface of the second holding section and presses the second holding section downward; and
a fixing mechanism which holds the first holding section to fix a vertical location of the first holding section to a predetermined location.

8. The bonding apparatus of claim 7, wherein the pressing mechanism and the fixing mechanism are supported by a supporting plate which is formed on an upper side of the second holding section.

9. The bonding apparatus of claim 7, wherein the pressing mechanism comprises a container which is formed so as to freely expand and contract in the vertical direction and cover at least the second member, and presses the second holding section by introducing a fluid into the container.

10. The bonding apparatus of claim 5, further comprising a position adjusting mechanism which controls the moving mechanism so that a horizontal location of the first member is aligned with the second member.

11. The bonding apparatus of claim 1, wherein at least one of the first holding section and the second holding section comprises a heating mechanism which heats at least one of the first member and the second member.

12. The bonding apparatus of claim 11, wherein at least one of the first holding section and the second holding section comprises a cooling mechanism which cools down at least one of the first member and the second member.

13. The bonding apparatus of claim 1, wherein the second holding section adsorbs and holds the second member by suction.

14. A bonding method of bonding two members to each other by using a bonding apparatus, the bonding apparatus comprising:
a first holding section which places and holds a first member on an upper surface thereof;
a second holding section which is formed above and facing the first holding section and holds a second member on a lower surface thereof; and
an intake mechanism which sucks atmosphere between the first holding section and the second holding section,
wherein the second holding section is an elastic body, a portion of which bends due to a predetermined pressure,
the bonding method comprising:
disposing the first holding section and the second holding section so that a vertical distance between the first holding section and the second holding section becomes a predetermined distance;
intaking atmosphere between the first holding section and the second holding section so that a portion of the second holding section which holds the second member bends and the bent portion of the second member abuts on the first member; and
further intaking the atmosphere between the first holding section and the second holding section so that an entire surface of the second member is bonded to an entire surface of the first member.
